(19) United States
(12) Patent Application Publication
(10) Pub. No.: US 2026/0244124 A1
(43) Pub. Date: Aug. 20, 2026

(54) LIGHT EMITTING DEVICE, AND OPTICAL WRITING DEVICE AND IMAGE FORMING SYSTEM USING THE LIGHT EMITTING DEVICE

(71) Applicant: FUJIFILM Business Innovation Corp., Tokyo (JP)

(72) Inventors: Kazuhiro Yoshino, Kanagawa (JP); Shinji Tsuruta, Kanagawa (JP); Yusuke Niisaka, Kanagawa (JP)

(73) Assignee: FUJIFILM Business Innovation Corp., Tokyo (JP)

(21) Appl. No.: 19/276,962

(22) Filed: Jul. 22, 2025

(30) Foreign Application Priority Data
Feb. 20, 2025 (JP) 2025-025624

(51) Int. Cl. G03G 15/041; B41J 2/447; B41J 2/47; B41J 29/393; G03G 15/00; G03G 15/04

(52) U.S. Cl. CPC G03G 15/0415; B41J 2/447; B41J 2/47; B41J 29/393; G03G 15/04036; G03G 15/5004; G03G 15/80

(57) ABSTRACT

A light emitting device includes a light source unit in which multiple light emitting elements are arranged along a principal scanning direction; a turning-on drive unit that outputs a turning-on signal for causing the light emitting elements to emit light to the light emitting elements, and that drives the light emitting elements to turn on so as to change a turning-on time width of the turning-on signal on a basis of a light amount of light to be emitted; and a voltage switching unit that switches to change a power supply voltage to be supplied to the light emitting elements, in which the voltage switching unit includes a number limiting unit that limits a number of times of switching of the power supply voltage.

### CROSS-REFERENCE TO RELATED APPLICATIONS

This application is based on and claims priority under 35 USC 119 from Japanese Patent Application No. 2025-025624 filed Feb. 20, 2025.

### BACKGROUND

### (i) Technical Field

The present disclosure relates to a light emitting device, and an optical writing device and an image forming system using the light emitting device.

### (ii) Related Art

There have already been known image forming systems that use a light emitting device according to the related art, such as those described in Japanese Unexamined Patent Application Publication No. 2007-105921 (Best Mode for Carrying Out the Invention and FIG. 8) and Japanese Unexamined Patent Application Publication No. 2018-030336 (Exemplary Embodiment of the Invention and FIG. 10).

Japanese Unexamined Patent Application Publication No. 2007-105921 discloses a print head including: a signal generation circuit that outputs a turning-on signal for causing a light emitting device (LED) to emit light, and that controls the light amount of the LED by fixing the pulse width of the turning-on signal to a predetermined value or changing the pulse width of the turning-on signal in a region of the predetermined value or more; and a power supply voltage control unit that changes the value of a power supply voltage to be supplied to the LED when the signal generation circuit fixes the pulse width of the turning-on signal to the predetermined value.

Japanese Unexamined Patent Application Publication No. 2018-030336 discloses an image forming device, in which when sequentially performing control for turning on or turning off each of a plurality of light emitting thyristors on the basis of the value of each pixel of input image data, a light exposure amount control unit switches the voltage to be applied to the light emitting thyristors using a voltage switching unit by selecting one of two voltages, thereby adjusting the turning-on time to achieve a required light exposure amount. In the image forming device, an overlapping range of two adjustment ranges of the light exposure amount that may be achieved by changing the turning-on time in a state in which the lower voltage and the higher voltage are respectively applied to the light emitting thyristors is set to be wider than a maximum light exposure amount variation range which is the range in which the required light exposure amount is assumed to vary during execution of a printing process based on one printing job.

### SUMMARY

Aspects of non-limiting embodiments of the present disclosure relate to providing a light emitting device that makes it possible to increase the light amount control range of a plurality of light emitting elements by suppressing the number of light amount difference phenomena of the light emitting elements caused when switching a power supply voltage to be supplied to the light emitting elements, without frequently switching the power supply voltage, when variably controlling the light amount of the light emitting elements by supplying the light emitting elements with the power supply voltage which is switchable into a turning-on signal that changes in the turning-on time width, and providing an optical writing device and an image forming system in which the light emitting device is used.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a light emitting device including: a light source unit in which a plurality of light emitting elements are arranged along a principal scanning direction; a turning-on drive unit that outputs a turning-on signal for causing the light emitting elements to emit light to the light emitting elements, and that drives the light emitting elements to turn on so as to change a turning-on time width of the turning-on signal on a basis of a light amount of light to be emitted; and a voltage switching unit that switches to change a power supply voltage to be supplied to the light emitting elements, in which the voltage switching unit includes a number limiting unit that limits a number of times of switching of the power supply voltage.

### BRIEF DESCRIPTION OF THE DRAWINGS

An exemplary embodiment of the present disclosure will be described in detail based on the following figure, wherein:

FIG. 1A illustrates an overview of an image forming system according to an exemplary embodiment of the present disclosure, FIG. 1B illustrates an example of the configuration of a light emitting device that is used in FIG. 1A, and FIG. 1C illustrates the function of the light emitting device;

FIG. 2 illustrates the overall configuration of the image forming system according to a first exemplary embodiment;

FIG. 3 illustrates an example of an exposure unit as an optical writing device that is used in the image forming system according to the first exemplary embodiment;

FIG. 4A illustrates an example of the configuration of a light emitting element chip array that is used in a light emitting device (LED) print head illustrated in FIG. 3, and FIG. 4B illustrates the arrangement relationship of light emitting element chips of the light emitting element chip array illustrated in FIG. 4A;

FIG. 5 illustrates an example of the circuit configuration of the light emitting element chip;

FIG. 6 is a block diagram illustrating an example of a signal generation circuit that generates a control signal for the light emitting element chip array;

FIG. 7 is a flowchart illustrating an example of a process of switching a power supply voltage for the print head that is used in the first exemplary embodiment;

FIG. 8 illustrates an example of a system that detects the film thickness of a photoconductor;

FIG. 9 is a flowchart illustrating a film thickness detection method in which the system that detects the film thickness of a photoconductor is used;

FIG. 10 illustrates an example of light amount control for the print head that is used in the first exemplary embodiment;

FIG. 11A indicates that the light amounts at point A of light amount control 1 and point B of light amount control 2 indicated in FIG. 8 are approximately the same, FIG. 11B indicates that a light amount difference phenomenon is caused between points A and B, and FIG. 11C illustrates an example of a method of correcting unevenness in light exposure amount;

FIG. 12 illustrates an example of light amount control for a print head that is used in Comparative Embodiment 1;

FIG. 13 illustrates another example of the light amount control for the print head that is used in the first exemplary embodiment;

FIG. 14 illustrates an example of light amount control for a print head that is used in Modified Embodiment 1; and

FIG. 15 illustrates an example of light amount control for a print head that is used in Modified Embodiment 2.

### DETAILED DESCRIPTION

### Overview of Exemplary Embodiment

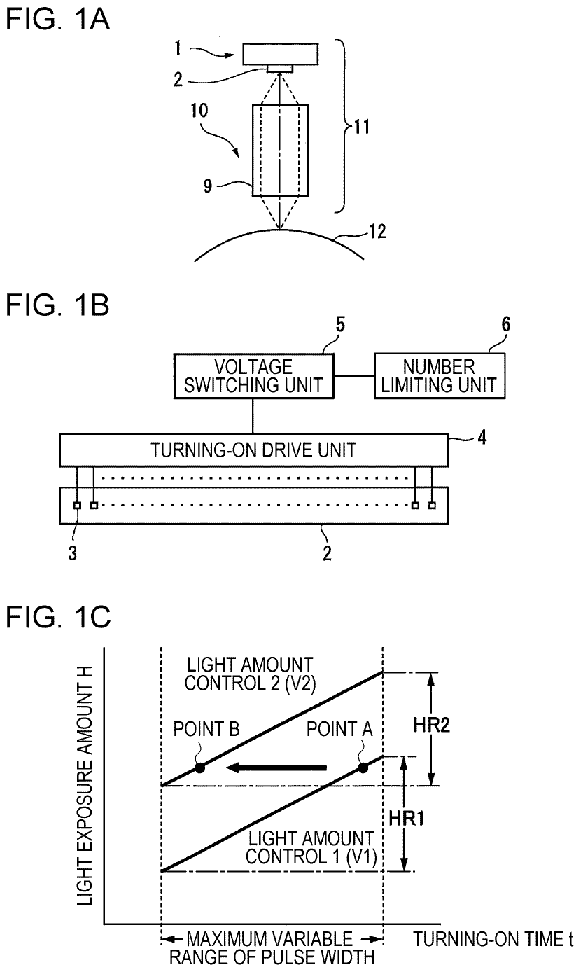

FIG. 1A illustrates an overview of an image forming system according to an exemplary embodiment of the present disclosure.

In the drawing, an image forming system 10 includes an optical writing device 11, and an image holding unit 12 provided to face the optical writing device 11 and hold an optical image written by the optical writing device 11.

Here, the optical writing device 11 includes a light emitting device 1, and an imaging unit 9 that forms an image on an image holding unit 12, which is capable of holding an optical image, using light emitted from a light source unit 2 of the light emitting device 1, and writes an optical image onto the image holding unit 12.

While typical examples of the image holding unit 12 here include a photoconductor, a dielectric or the like that converts optical information into a potential pattern is also included. The form of the image holding unit 12 may be selected as appropriate, and may be a drum shape, a belt shape, or the like. Examples of the optical image include an electrostatic latent image, which is formed with a potential difference generated by charging to a predetermined level and then eliminating electricity using light in an image pattern.

The imaging unit 9 may be selected as appropriate, as long as the imaging unit 9 forms an image on the image holding unit 12 using light emitted from the light source unit 2 of the light emitting device 1. Specifically, the imaging unit 9 may be a lens (e.g. a cylindrical lens) that refracts light on its surface, or may be a lens (e.g. a gradient index lens) that internally refracts light.

In the present exemplary embodiment, as illustrated in FIGS. 1A and 1B, the light emitting device 1 includes a light source unit 2 in which a plurality of light emitting elements 3 are arranged along a principal scanning direction, a turning-on drive unit 4 that outputs a turning-on signal for causing the light emitting elements 3 to emit light to the light emitting elements 3, and that drives the light emitting elements 3 to turn on so as to change the turning-on time width of the turning-on signal on the basis of a light amount of light to be emitted, and a voltage switching unit 5 that switches to change a power supply voltage to be supplied to the light emitting elements 3. The voltage switching unit 5 includes a number limiting unit 6 that limits the number of times of switching of the power supply voltage.

In such a device, the light source unit 2 may be an array in which the plurality of light emitting elements 3 are arranged in the principal scanning direction. Here, the light emitting elements 3 may be light emitting devices (LEDs) including light emitting thyristors, light emitting diodes, etc. The plurality of light emitting elements 3 may be divided into a plurality of chips to be arranged, and such chips may be arranged in a staggered manner.

The turning-on drive unit 4 outputs a turning-on signal for turning on each of the light emitting elements 3, and adjusts to a desired light emission amount by changing the width (pulse width) of a turning-on time t of the turning-on signal. The “light amount of light to be emitted” is selected in correspondence with the gradation level of image data, for example.

Further, the voltage switching unit 5 switches the power supply voltage to be supplied to the light emitting elements 3 from V1 to V2 (>V1), for example. Consequently, the range of light amount control from the light emitting elements 3 includes both the range by light amount control 1 and the range by light amount control 2 (see FIG. 1C). Here, the “light amount control 1” is the range of light amount control (corresponding to “HR1” in FIG. 1C) in which a first power supply voltage V1 is used. Meanwhile, the “light amount control 2” is the range of light amount control (corresponding to “HR2” in FIG. 1C) in which a second power supply voltage V2 is used.

In the present example, the number of times of switching of the power supply voltage to be supplied to the light emitting elements 3 is limited by the number limiting unit 6. The number of times of switching is not limited to one, and may be a plural number of times.

With such a light emitting device 1, as illustrated in FIG. 1C, a wide range of light amount control may be obtained compared to the case where the power supply voltage to be supplied to the light emitting elements 3 is fixed.

Further, for the voltage switching unit 5 according to the present example, the number of times of switching of the power supply voltage to be supplied to the light emitting elements 3 is limited by the number limiting unit 6. Therefore, the power supply voltage is not switched indefinitely in the present example.

In general, there is an aspect in which there is an overlapping region in which the “light amount control 1” and the “light amount control 2” partially overlap each other. In this aspect, it is possible to control the amount of light at point A with the first power supply voltage V1 before the switching and the amount of light at point B with the second power supply voltage V2 after the switching to approximately the same level. However, there is a concern that even if the amount of light is controlled to approximately the same level by adjusting the turning-on time width of the light emitting elements 3 when switching the power supply voltage, the amount of light is likely to differ and the color taste is likely to change. In this manner, it is difficult to avoid the aforementioned light amount difference phenomenon when switching the power supply voltage. However, it is possible to suppress the aforementioned light amount difference phenomenon by limiting the number of times of switching of the power supply voltage.

Next, a typical aspect or a preferable aspect of the light emitting device 1 according to the present exemplary embodiment will be described.

First of all, for the number limiting unit 6, the number of times of switching is preferably one. In this case, switching may be made to the second power supply voltage V2 after the switching, which is higher than the first power supply voltage V1 before the switching (see FIG. 1C). It is also possible to set the number of times of switching to a plural number of times determined in advance. In this case, when switching the power supply voltage, switching is preferably made to the second power supply voltage V2 after the switching, which is higher than the first power supply voltage V1 before the switching. For example, when the number of times of switching is two, it is assumed that the power supply voltages to be selected include Va, Vb, and Vc (Va<Vb<Vc). In this case, switching of the power supply voltage is made from Va (V1) to Vb (V2) in the first switching, and from Vb (V1) to Vc (V2) in the second switching.

In a preferable aspect of the voltage switching unit 5, the first light amount control range with the first power supply voltage V1 before the switching and the second light amount control range with the second power supply voltage V2 after the switching partially overlap each other, and the overlapping region occupies a region of one-third or more of the second light amount control range. This means that even if the first power supply voltage V1 is switched to the second power supply voltage V2, the second light amount control range covers a light amount in the range of one-third or more of the first light amount control range. Consequently, it is possible to obtain a light amount in the range of one-third or more of the light amount obtained with the first light amount control range after switching to the second power supply voltage V2, without switching to the first power supply voltage V1. In particular, in order for the second light amount control range to include more of the first light amount control range, the overlapping region preferably occupies a region of a half or more of the second light amount control range.

Further, in a preferable aspect of the turning-on drive unit 4, a region inside the maximum variable region of the turning-on time width of the turning-on signal is used as the turning-on time width. This aspect is made in consideration of the fact that the light amount of the light emitting elements 3 tends to be unstable near the minimum and maximum values of the maximum variable region.

Next, a typical aspect or a preferable aspect of the timing for the voltage switching unit 5 to switch the power supply voltage will be described.

In the image forming system 10, in a preferable aspect, the voltage switching unit 5 switches the power supply voltage depending on the state of use of the image holding unit 12. The image holding unit 12 changes the properties of holding an optical image over time depending on the state of use. However, in the present example, it is effective to use the power supply voltage of the light emitting elements 3 that is suitable for the state of use of the image holding unit 12, in order to hold the properties of holding an optical image uniform.

For example, in an aspect in which the image holding unit 12 is composed of a photoconductor covered with a photosensitive layer, the voltage switching unit 5 preferably switches the power supply voltage depending on the film thickness of the photosensitive layer.

The aforementioned light amount difference phenomenon may occur when the voltage switching unit 5 switches the power supply voltage. Therefore, it is not preferable if the voltage switching unit 5 switches the power supply voltage while the image forming system 10 is performing an imaging process.

Thus, in the present example, in a preferable aspect of the voltage switching unit 5, switching of the power supply voltage is not performed while the optical writing device 11 is performing an image writing process onto the image holding unit 12 and while the optical writing device 11 is standing by in an identical image writing process. In a typical aspect of the voltage switching unit 5, the power supply voltage is switched when the image forming system 10 is started.

The present disclosure will be described in more detail below with reference to an exemplary embodiment illustrated in the accompanying drawings.

### First Exemplary Embodiment

### Overall Configuration of Image Forming System

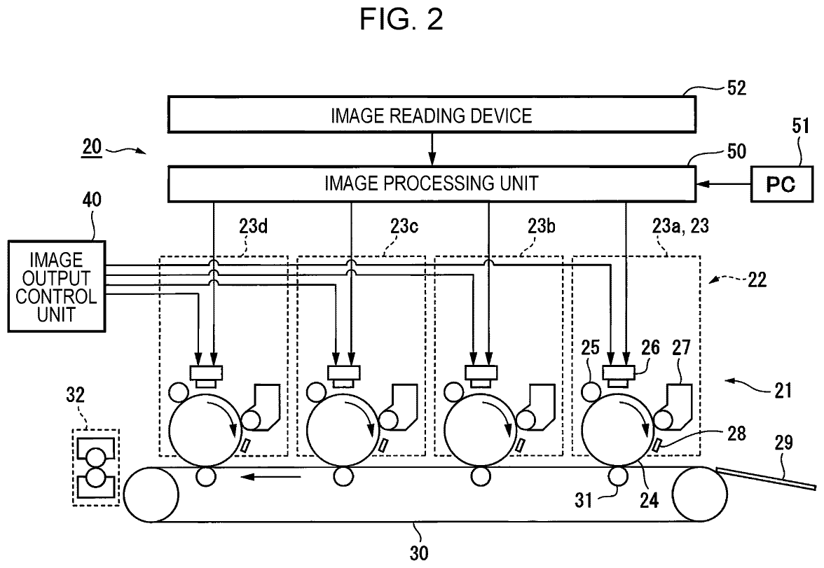

FIG. 2 illustrates the overall configuration of an image forming system according to a first exemplary embodiment.

In the drawing, an image forming system 20 is an image forming system commonly referred to as a tandem type. The image forming system 20 includes an image formation processing unit 21, an image output control unit 40, and an image processing unit 50. Here, the image formation processing unit 21 is a functional unit that performs image formation corresponding to image data for various colors. The image output control unit 40 is a functional unit that controls the image formation processing unit 21. Further, the image processing unit 50 is connected to a personal computer (PC) 51 and an image reading device 52, for example, and performs image processing determined in advance on image data received from the PC 51 and the image reading device 52.

The image formation processing unit 21 includes image forming units 22, which are arranged in parallel at certain intervals. The image forming units 22 are composed of four imaging engines 23 (23a to 23d), which are examples of a toner image forming unit. The toner image forming unit here is a functional unit that forms toner images in four colors (yellow (Y), magenta (M), cyan (C), and black (K) in the present example). The imaging engines 23 (23a to 23d) each include an image holding unit that forms an electrostatic latent image and holds a toner image. In the present example, a drum-shaped photoconductor 24, for example, is used as an example of the image holding unit. A charging unit 25, an exposure unit 26 as the optical writing device, and a developing unit 27 are provided around the photoconductor 24. Here, the charging unit 25 uniformly charges the surface of the photoconductor 24 to a potential determined in advance. The exposure unit 26 exposes the photoconductor 24 charged by the charging unit 25 to light to form an electrostatic latent image. The developing unit 27 develops the electrostatic latent image formed by the exposure unit 26.

The imaging engines 23 (23a to 23d) form toner images for yellow (Y), magenta (M), cyan (C), and black (K), respectively.

In the image formation processing unit 21, the toner images in the respective colors formed on the photoconductor 24 of the imaging engines 23 (23a to 23d) are transferred in a multiplexed manner to recording paper 29 as an example of a recording medium and fixed. In the present example, the image formation processing unit 21 includes a paper transport belt 30, a transfer unit 31, and a fixing unit 32. Here, the paper transport belt 30 transports the recording paper 29. The transfer unit 31 transfers the toner image on the photoconductor 24 to the recording paper 29, and is a transfer roll in the present example. The fixing unit 32 fixes the toner images transferred to the recording paper 29.

In the image forming system 20, the image formation processing unit 21 performs image forming operation on the basis of various control signals supplied from the image output control unit 40. When image data are received from the personal computer (PC) 51 or the image reading device 52, the following processes are performed. The image data are subjected to image processing by the image processing unit 50 under the control of the image output control unit 40, and supplied to the imaging engines 23.

In the imaging engine 23d for black (K), for example, the photoconductor 24 is charged to a potential determined in advance by the charging unit 25 while rotating in the direction of the arrow. After that, the photoconductor 24 is exposed by the exposure unit 26 which emits light on the basis of the image data supplied from the image processing unit 50. Consequently, an electrostatic latent image for a black (K) image is formed on the photoconductor 24. The electrostatic latent image formed on the photoconductor 24 is developed by developing unit 27, and a toner image for black (K) is formed on the photoconductor 24. Similarly, the imaging engines 23 (23a to 23c) also form toner images for yellow (Y), magenta (M), cyan (C), and black (K), respectively.

The toner images in the respective colors on the photoconductors 24 formed by the imaging engines 23 (23a to 23d) are transferred in a multiplexed manner onto the recording paper 29. In the present example, the recording paper 29 is supplied along with the movement of the paper transport belt 30, which moves in the direction of the arrow. The toner images in the respective colors are sequentially subjected to an electrostatic transfer to the recording paper 29 by a transfer field applied to the transfer unit (transfer roll) 31. Therefore, a composite toner image is formed in which toners in the various colors are superimposed on the recording paper 29.

After that, the recording paper 29 on which the composite toner image has been transferred through an electrostatic transfer is transported to the fixing unit 32. The composite toner image on the recording paper 29 is subjected to a fixing process using heat and a pressure by the fixing unit 32 to be fixed onto the recording paper 29, and ejected from the image forming system 20.

Any residue (residual toner, paper dust, etc.) on the photoconductor 24 and the paper transport belt 30 is cleaned by a cleaner (not illustrated) as appropriate.

### Configuration Example of Exposure Unit

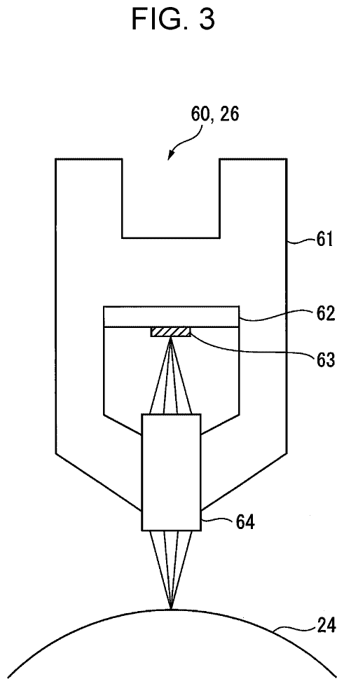

FIG. 3 illustrates an example of the configuration of the exposure unit 26 that is used in the present exemplary embodiment.

In the drawing, the exposure unit 26 is composed of an LED print head (hereinafter abbreviated as an “LPH”) 60, which uses LEDs as light emitting elements.

The LPH 60 includes a holder 61 as a holding member, a light emitting element chip array 63 that constitutes a light emitting unit, and an imaging lens 64 as an example of an imaging unit.

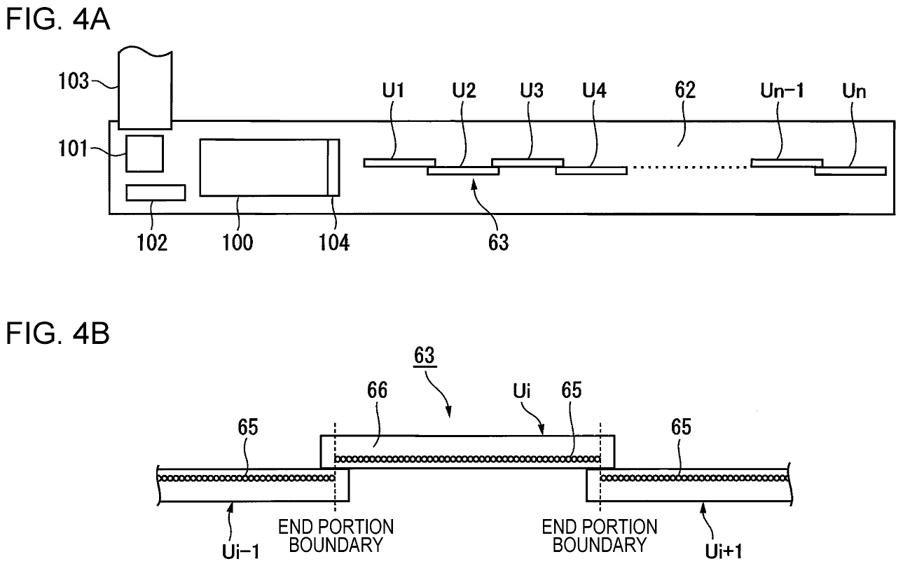

In the present example, the light emitting element chip array 63 is composed of a self-scanning light emitting device (LED) array, for example. The light emitting element chip array 63 is driven by a drive signal from a drive circuit (signal generation circuit) 100 as a drive signal generating unit. In the present example, the light emitting element chip array 63, the signal generation circuit 100 (see FIG. 4A), etc., are mounted on a circuit substrate 62. The imaging lens 64 is an optical member that forms an image on the surface of the photoconductor 24 using light from the light emitting element chip array 63, and is composed of a rod lens array, for example.

In the present example, the holder 61 is formed from a block or a metal sheet of aluminum, SUS, or the like, and holds the circuit substrate 62 and the imaging lens 64. The holder 61 is designed to match the light emitting point of the LEDs (see FIG. 4B) as light emitting elements 65 of the light emitting element chip array 63 with the focal plane of the imaging lens 64. Rod lenses as the imaging lens 64 are disposed along the axial direction of the photoconductor 24 (corresponding to the principal scanning direction).

The thus configured LPH 60 is configured to be movable in the optical axis direction of the imaging lens 64 by means of an adjustment screw (not illustrated), and adjusted such that the imaging position (focal plane) of the imaging lens 64 is positioned on the surface of the photoconductor 24.

### Configuration Example of Wires on Circuit Substrate

FIG. 4A is a plan view of the circuit substrate 62.

In the drawing, in the light emitting element chip array 63, a plurality of light emitting element chips U (specifically, U1 to Un) are disposed on the circuit substrate 62. In the present example, the light emitting element chips U are disposed in a staggered manner in two rows facing each other in the axial direction of the photoconductor 24 (corresponding to the principal scanning direction). Each light emitting element chip U (U1 to Un) includes a chip substrate 66, and the light emitting elements 65 are arranged in the principal scanning direction on each chip substrate 66.

In the present example, the light emitting element chips U (U1 to Un) are arranged in a staggered manner for the following reason. If the plurality of light emitting element chips U were arranged in one direction, there would be a concern that the intervals of the light emitting elements 65 at the ends of the light emitting element chips U might not be constant. In order to avoid such a situation, the light emitting element chips U may be arranged in a staggered manner so that the ends of the light emitting element chips U partially overlap each other, as illustrated in FIG. 4B. In this manner, it is possible to obtain a structure in which the intervals of the light emitting elements 65 at the ends of the light emitting element chips U (Ui−1, UI, Ui+1) are kept constant.

As illustrated in FIG. 4A, the circuit substrate 62 includes the signal generation circuit 100, a level shift circuit 104, a 3-terminal regulator 101 that outputs the power supply voltage, an electrically erasable programmable read-only memory (EEPROM) 102 that stores light amount correction value data for the light emitting element chip array 63, and a harness 103 that is used to transmit and receive signals to and from the image output control unit 40 and the image processing unit 50 of the image forming system 20.

### Configuration Example of Light Emitting Element Chip Array

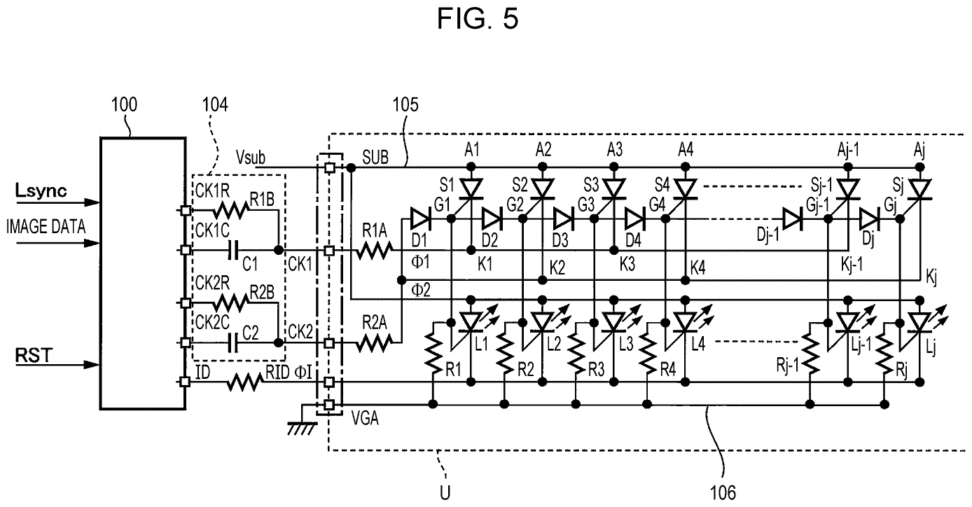

FIG. 5 illustrates the circuit configuration of the light emitting element chip array 63.

In the drawing, the light emitting element chip array 63 is connected to the signal generation circuit 100 via the level shift circuit 104. The level shift circuit 104 has a configuration in which a resistor R1B and a capacitor C1, and a resistor R2B and a capacitor C2, are disposed in parallel. One end of each of the resistors and the capacitors is connected to the input terminal of the light emitting element chip array 63, and the other end is connected to the output terminal of the signal generation circuit 100. Transfer signals CK1R, CK1C and transfer signals CK2R, CK2C are output from the signal generation circuit 100. Based on these output signals, transfer signals CK1 and CK2 are output to the light emitting element chip array 63.

In the light emitting element chip array 63 according to the present exemplary embodiment, a plural number n (e.g. n=58) of light emitting element chips U are arranged in series. However, only one light emitting element chip U is illustrated in FIG. 5.

As illustrated in FIG. 5, each light emitting element chip U is composed of j (e.g. j=128) thyristors S1 to Sj as switching elements, j LEDs L1 to Lj as light emitting elements, j diodes D1 to Dj, j resistors R1 to Rj, and transfer current limiting resistors R1A, R2A that prevent an excessive current flow through signal lines.

Here, a portion principally composed of the thyristors S1 to Sj and the diodes D1 to Dj to control the supply of a current to the LEDs L1 to Lj is called a transfer unit.

In the present exemplary embodiment, in each light emitting element chip U, respective anode terminals (input ends) A1 to Aj of the thyristors S1 to Sj are connected to a power supply line 105. A power supply voltage Vsub for each light emitting element chip U is supplied to the power supply line 105.

The transfer signal CK1 is transmitted from the signal generation circuit 100 to respective cathode terminals (output ends) K1, K3, . . . , Kj−1 of the odd-numbered thyristors S1, S3, . . . , Sj−1 via the level shift circuit 104 and the transfer current limiting resistor R1A.

The transfer signal CK2 is transmitted from the signal generation circuit 100 to respective cathode terminals (output ends) K2, K4, . . . , Kj of the even-numbered thyristors S2, S4, . . . , Sj via the level shift circuit 104 and the transfer current limiting resistor R2A.

On the other hand, respective gate terminals (control ends) G1 to Gj of the thyristors S1 to Sj are connected to a power supply line 106 via the resistors R1 to Rj provided in correspondence with the thyristors S1 to Sj. The power supply line 106 is grounded (GND).

The gate terminals G1 to Gj of the thyristors S1 to Sj and the gate terminals of the LEDs L1 to Lj provided in correspondence with the thyristors S1 to Sj are connected, respectively.

The cathode terminals of the diodes D1 to Dj are connected to the gate terminals G1 to Gj of the thyristors S1 to Sj, respectively. The anode terminals of the diodes D2 to Dj in the next stage are connected to the gate terminals G1 to Gj-1 of the thyristors S1 to Sj−1, respectively. That is, the diodes D1 to Dj are connected in series with the gate terminals G1 to Gj−1 interposed therebetween.

The anode terminal of the diode D1 is connected to the signal generation circuit 100 via the transfer current limiting resistor R2A and the level shift circuit 104 to receive the transfer signal CK2. The cathode terminals of the LEDs L1 to Lj are connected to the signal generation circuit 100 to receive a turning-on signal ΦI.

### Configuration Example of Signal Generation Circuit

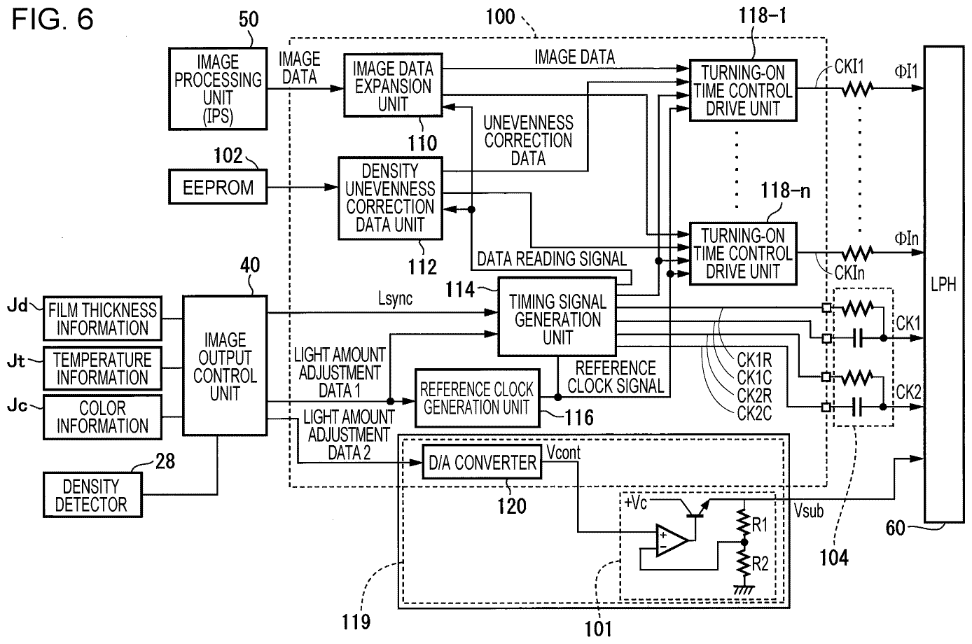

FIG. 6 is a block diagram illustrating the configuration of the signal generation circuit 100.

The principal part of the signal generation circuit 100 is composed of an image data expansion unit 110, a density unevenness correction data unit 112, a timing signal generation unit 114, a reference clock generation unit 116, and turning-on time control drive units 118 (specifically, 118-1 to 118-n) provided in correspondence with the respective light emitting element chips U (U1 to Un).

### Image Data Expansion Unit

Image data are transmitted serially from the image processing unit (IPS) 50 to the image data expansion unit 110. The image data expansion unit 110 divides the transmitted image data into image data for the first to j-th dots, (j+1)-th to (2×j)-th dots, . . . , {(n−1)×j+1}-th to (n×j)-th dots and image data for the light emitting element chips U (U1 to Un). The image data expansion unit 110 is connected to the turning-on time control drive units 118, and outputs the divided image data to the corresponding turning-on time control drive units 118-1 to 118-n.

### Density Unevenness Correction Data Unit

The density unevenness correction data unit 112 stores density unevenness correction data for correcting image density unevenness at the time of image formation due to variations in the light amount of each LED in each light emitting element chip U, etc. Then, the density unevenness correction data unit 112 outputs the density unevenness correction data to the turning-on time control drive units 118 in synchronization with a data reading signal from the timing signal generation unit 114. The density unevenness correction data are data set in accordance with variations in the light amount of each LED, etc., and are formed as 8-bit data, for example, in the present exemplary embodiment.

The EEPROM 102 stores light amount correction value data for each LED. When the machine power supply is turned on, the light amount correction value data for each LED are downloaded from the EEPROM 102 to the density unevenness correction data unit 112. As a result, the light amount correction value data are stored as the density unevenness correction data in the density unevenness correction data unit 112.

Here, the light amount correction value data for each LED stored in the EEPROM 102 are obtained as follows. The light amount correction value data for each LED are generated on the basis of light amount data measured by measuring the light amount of each LED using a light profile measurement device or the like.

First, the LPH 60 is installed in the light profile measurement device, and each LED is turned on to measure light amount distribution data for each LED. For the measured light amount distribution data, the light amount distribution (light profile) in the principal scanning direction is obtained by calculating an integrated value in a direction (sub-scanning direction) orthogonal to the principal scanning direction at each coordinate position in the LED arrangement direction (principal scanning direction).

Subsequently, the light amount (exposure energy) density for a region between a valley and a valley in the light profile is calculated by integrating the light amount from the valley to the valley and dividing the integrated value by the distance from the valley to the valley. The exposure energy density for each region obtained in this manner is used as a correction characteristic value for each LED. In order to match the correction characteristic value with a predetermined target value, the light amount is increased and decreased in accordance with an error from the target value, so that the correction characteristic value becomes flat (even) for all the regions. The light amount correction value for each region that has been flattened is used as a light amount correction value for each LED.

### Reference Clock Generation Unit

The reference clock generation unit 116 is connected to the image output control unit 40, the timing signal generation unit 114, and the turning-on time control drive units 118 (118-1 to 118-n).

In the present example, the reference clock generation unit 116 is configured to include a phase-locked loop (PLL) circuit composed of a quartz oscillator, frequency dividers, a phase comparator, and a voltage-controlled oscillator, and a look-up table (LUT).

The LUT stores a table for determining frequency division ratios M, N on the basis of light amount adjustment data 1 from the image output control unit 40. The quartz oscillator is connected to a frequency divider 1/N, oscillates at a predetermined frequency, and outputs an oscillated signal to the frequency divider 1/N. The frequency divider 1/N is connected to the LUT and the phase comparator, and divides the signal oscillated by the quartz oscillator on the basis of the frequency division ratio N from the LUT determined on the basis of the light amount adjustment data 1. The phase comparator is connected to a frequency divider 1/M, the frequency divider 1/N, and the voltage-controlled oscillator, and compares an output signal from the frequency divider 1/M and an output signal from the frequency divider 1/N. A control voltage to be supplied to the voltage-controlled oscillator is controlled in accordance with the result of the comparison (phase difference) by the phase comparator. The voltage-controlled oscillator outputs a reference clock signal at a frequency based on the control voltage. In the present exemplary embodiment, a control voltage corresponding to a frequency that divides the turning-on period into 256 is supplied, and a reference clock signal at this frequency is generated and output to all the turning-on time control drive units 118 (118-1 to 118-n). The voltage-controlled oscillator is also connected to the frequency divider 1/M, and the reference clock signal output from the voltage-controlled oscillator is branched and also input to the frequency divider 1/M. The frequency divider 1/M divides the frequency of the reference clock signal fed back from the voltage-controlled oscillator on the basis of the frequency division ratio M from the LUT determined on the basis of the light amount adjustment data 1.

### Light Amount Adjustment Data 1

In the present example, in the four imaging engines 23 (23a to 23d), as illustrated in FIG. 2, a toner image as a test patch (density sample) is formed on the photoconductor 24 at a predetermined timing, and the density detector 28 detects the toner image density. Toner image density data detected by the density detector 28 are output to the image output control unit 40 as illustrated in FIG. 6. In the image output control unit 40, the light amount adjustment data 1 are generated by computing the light amount at the LPH 60 from the input toner image density data. The generated light amount adjustment data 1 are output to the reference clock generation unit 116.

In the present example, there is a concern that the density of the toner image formed as a test patch may vary. Variations in the density of the toner image are caused by variations in sensitivity of the photoconductor 24, variations in latent image potentials (dark portion potential and bright portion potential), and variations in amount of a developer in the developing unit 27, for example. Therefore, in the present example, the light amount adjustment data 1 are data that are used to adjust the overall light amount of the LPH 60 (the light amount of all the LEDs in the LPH 60) in order to keep the aforementioned variations constant. Therefore, the light amount adjustment data 1 are output as an indication value that indicates the pulse width of the turning-on signal ΦI for driving each light emitting element chip U of the LPH 60.

Since the overall light amount of the LPH 60 becomes larger as the pulse width of the turning-on signal ΦI becomes longer, it is meant that the overall light amount of the LPH 60 is set to be larger as the pulse width indication value is larger.

### Operation Example of Reference Clock Generation Unit

In this manner, the reference clock generation circuit 116 changes the period of the reference clock signal on the basis of the light amount adjustment data 1. As a result, by increasing the period of the reference clock signal, it is possible to increase the pulse width of the turning-on signal ΦI and increase the light amount of the LEDs. On the other hand, by reducing the period of the reference clock signal, it is possible to reduce the pulse width of the turning-on signal ΦI and reduce the light amount of the LEDs.

### Timing Signal Generation Unit

The timing signal generation unit 114 is connected to the image output control unit 40 and the reference clock generation unit 116. The timing signal generation unit 114 generates transfer signals CK1R, CK1C and transfer signals CK2R, CK2C in synchronization with a horizontal synchronization signal (Lsync) from the image output control unit 40 on the basis of the reference clock signal from the reference clock generation unit 116. The transfer signals CK1R, CK1C and the transfer signals CK2R, CK2C are output to the LPH 60 as transfer signals CK1 and CK2 via the level shift circuit 104.

The timing signal generation unit 114 is also connected to the density unevenness correction data unit 112 and the image data expansion unit 110. The timing signal generation unit 114 outputs a data reading signal in synchronization with the horizontal synchronization signal (Lsync) from the image output control unit 40 on the basis of the reference clock signal from the reference clock generation unit 116. Here, examples of the data reading signal include a signal for reading image data corresponding to each pixel from the image data expansion unit 110. Examples of the data reading signal also include a signal for reading density unevenness correction data corresponding to each pixel (each LED) from the density unevenness correction data unit 112. Further, the timing signal generation unit 114 is also connected to the turning-on time control drive unit 118. The timing signal generation unit 114 outputs a trigger signal for starting to turn on each light emitting element chip U in synchronization with the horizontal synchronization signal (Lsync) from the image output control unit 40 on the basis of the reference clock signal from the reference clock generation unit 116.

### Turning-On Time Control Drive Unit

The turning-on time control drive units 118 (118-1 to 118-n) correct the turning-on time of each pixel (each LED) on the basis of the density unevenness correction data and delay selection data, and generate a control signal for turning on each pixel of each light emitting element chip U.

In the present example, the density unevenness correction data are stored in the density unevenness correction data unit 112 as described above.

The delay selection data are stored in the EEPROM 102.

Here, the delay selection data are additionally described as follows.

In general, when light is to be actually emitted from an LED, the output waveform of the turning-on signal ΦI is not completely rectangular, and thus the light emission start time is delayed, with a delay time usually with variations of about 3 to 15 nsec.

Thus, in the LPH 60 according to the present exemplary embodiment, a correction process is performed by a linearity correction unit (not illustrated). That is, the linearity correction unit offsets the pulse width of the turning-on signal ΦI such that the light amount characteristics of light from the LED substantially coincide with target light amount characteristics in a pulse width region that is used in the image forming device. In the present example, the offset amount is determined such that the light amount of the LED coincides with a target light amount at a pulse width (offset correction position) at the lower limit of the pulse width region that is used. The offset amount is measured for each LED in this manner, and stored in the EEPROM 102 as the delay selection data.

In this manner, in the present exemplary embodiment, the turning-on time control drive units 118 correct the turning-on pulse (pulse width) for each pixel (each LED) on the basis of the density unevenness correction data and the delay selection data. Therefore, in the present example, the turning-on time control drive units 118 substantially match the light amount characteristics in a pulse width that is used in the image forming device with the target light amount characteristics, and output the light amount characteristics to the LPH 60. As a result, the light amount of all the LEDs is set to be within a predetermined range in the pulse width region to be used.

### Power Supply Voltage Control Unit

In the present example, the power supply voltage control unit 119 controls the power supply voltage to be supplied to the LPH 60. Specifically, as illustrated in FIG. 6, the power supply voltage control unit 119 is configured to include a digital/analog (D/A) converter 120 and a 3-terminal regulator 101.

Here, the D/A converter 120 performs a digital-analog conversion on the light amount adjustment data 2 output from the image output control unit 40, and outputs a control voltage Vcont that matches the light amount adjustment data 2. The 3-terminal regulator 101 variably sets the power supply voltage Vsub for the LPH 60 in accordance with the control voltage Vcont output from the D/A converter 120.

### Light Amount Adjustment Data 2

In the present example, the light amount adjustment data 2 are data that indicate the necessity to switch the power supply voltage Vsub to be applied to the LPH 60.

In general, the photosensitive layer of the photoconductor 24 changes over time in accordance with the rotation time (number of sheets to be printed). Therefore, the sensitivity of the photoconductor 24 varies along with the change of the photoconductor 24 over time. In this case, the dark portion potential and the bright portion potential of the light image (electrostatic latent image) by the LPH 60 change, and the aforementioned light amount adjustment data 1 (adjustment data for the pulse width of the turning-on signal ΦI) are required. Further, in the present example, the light amount adjustment data 2 are used as data to adjust the light intensity of the light image (electrostatic latent image) by switching the power supply voltage Vsub to be applied to the LPH 60.

In particular, in the present example, focusing on the fact that the sensitivity of the photoconductor 24 depends on a film thickness d of the photosensitive layer of the photoconductor 24, the light amount adjustment data 2 are determined in consideration of film thickness information Jd on the photosensitive layer of the photoconductor 24.

In the present example, the light amount adjustment data 2 are used as data that indicate whether or not the film thickness d of the photosensitive layer of the photoconductor 24 is equal to or less than a threshold dth determined in advance.

The “threshold dth” here may be selected as appropriate in accordance with the change in the photosensitive characteristics of the photoconductor 24. In the present example, it is determined whether or not the film thickness d of the photosensitive layer of the photoconductor 24 is equal to or less than the threshold dth, and the film thickness information Jd is added to the light amount adjustment data 2.

### Operation Example of Power Supply Voltage Control Unit

First, a case where the film thickness d of the photosensitive layer of the photoconductor 24 is more than the threshold dth in the film thickness information Jd is described.

At this time, when the light amount adjustment data 2 are input to the D/A converter 120 of the power supply voltage control unit 119, the D/A converter 120 outputs a predetermined control voltage value Vcont1. Consequently, the 3-terminal regulator 101 sets the power supply voltage Vsub to be constant at a first power supply voltage V1.

On the contrary, a case where the film thickness d of the photosensitive layer of the photoconductor 24 is equal to or less than the threshold dth in the film thickness information Jd is described.

At this time, when the light amount adjustment data 2 are input to the D/A converter 120 of the power supply voltage control unit 119, the D/A converter 120 outputs a predetermined control voltage value Vcont2. Consequently, the 3-terminal regulator 101 sets the power supply voltage Vsub to be constant at a second power supply voltage V2.

In the present example, the second power supply voltage V2 is selected to be higher than the first power supply voltage V1.

### Power Supply Voltage Switching Process

In the present example, as illustrated in FIG. 6, the image output control unit 40 outputs the light amount adjustment data (light amount adjustment data 1 and light amount adjustment data 2) to the signal generation circuit 100 and the power supply voltage control unit 119.

The power supply voltage control unit 119 receives the light amount adjustment data 2, and switches the power supply voltage to be supplied to the LPH 60.

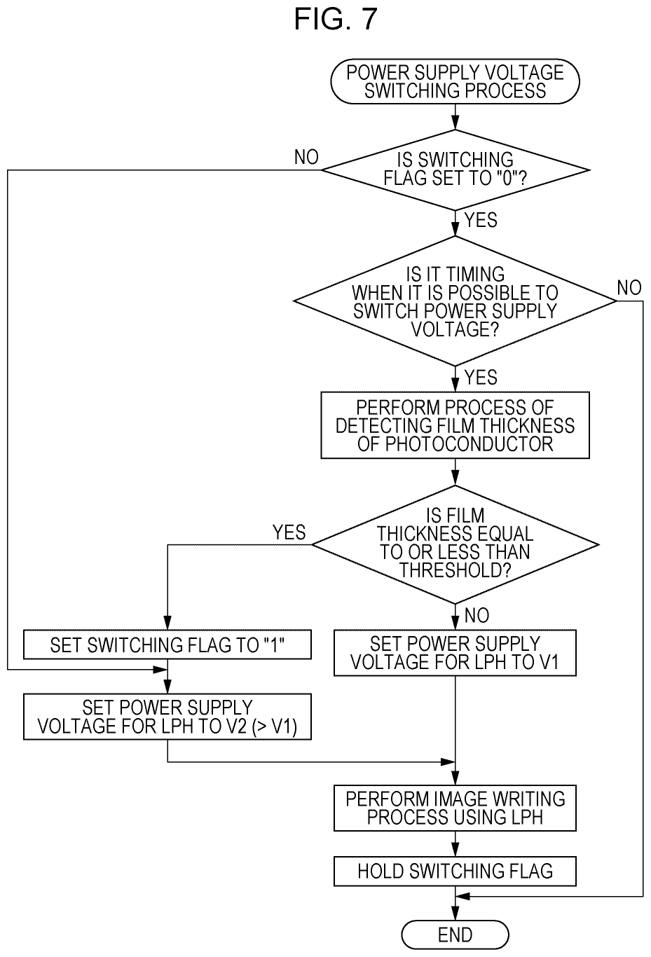

FIG. 7 is a flowchart illustrating a process of switching the power supply voltage for the LPH 60.

In the drawing, the image output control unit 40 checks whether or not a switching flag is set to “0” on the basis of the input film thickness information Jd.

The “switching flag” here is a flag for determining the necessity to switch the power supply voltage. The switching flag “0” means that it is not necessary to switch the power supply voltage. On the other hand, the switching flag “1” means that it is necessary to switch the power supply voltage.

Next, the image output control unit 40 determines whether or not it is the timing when it is possible to switch the power supply voltage.

In the present example, examples of the timing when it is possible to switch the power supply voltage include a time to start the image forming system 20. On the contrary, examples of the timing when it is not possible to switch the power supply voltage include the following.
(1) While the LPH 60 is performing an image writing process
(2) While the LPH 60 is standing by in an identical image writing process

This is because if the power supply voltage for the LPH 60 is switched in the case of (1) or (2), a light amount difference phenomenon is caused even if the same light exposure amount is set when switching the power supply voltage, resulting in a different color of the image.

After that, the image output control unit 40 performs a process of detecting the film thickness of the photoconductor when it is determined that it is the timing when it is possible to switch the power supply voltage.

An example of a process of detecting the film thickness of the photoconductor 24 will be described below.

### Example of Process of Detecting Film Thickness of Photoconductor

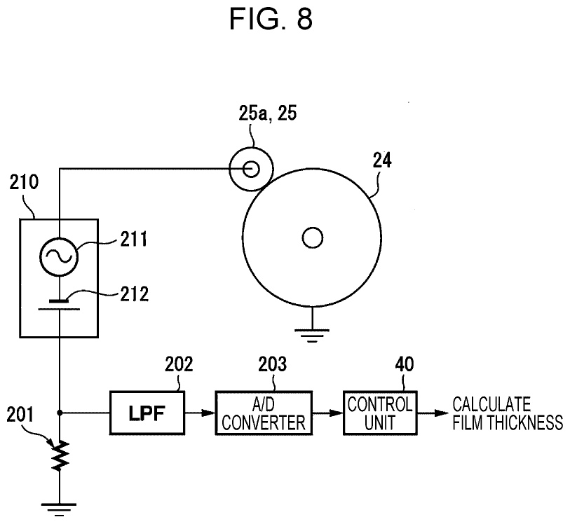

FIG. 8 illustrates an example of the configuration of a system that detects the film thickness of the photoconductor.

The film thickness detection system illustrated in the drawing utilizes a charging roller 25a of the charging unit 25 that charges the photoconductor 24, for example. The film thickness detection system includes a current-voltage conversion resistor 201 that converts a current that flows through the photoconductor 24 into a voltage, a low-pass filter (hereinafter referred to as an LPF) 202, an analog/digital (A/D) converter 203, and a control unit (corresponding to the image output control unit 40).

For the voltage detected by the current-voltage conversion resistor 201, for example, an alternating current (AC) component 211 and a direct current (DC) component 212 of a power supply unit 210 are superimposed on the charging roller 25a of the charging unit 25, for example, and therefore the AC frequency is attenuated with the LPF 202. By adding the LPF 202, it is possible to remove the AC component 211 and reduce the sampling frequency. According to the sampling theorem, the sampling period is set to a frequency that is equal to or more than twice the AC period of the power supply. In that case, it is conceivable that the load of digital processing increases as the number of data to be sampled increases.

Thus, by reducing the sampling frequency by removing the AC component 211 with the LPF 202, it is possible to reduce the load of digital processing without decreasing the detection accuracy.

The upper limit of the sampling period is set so as not to deteriorate the accuracy for the voltage change control time of the DC voltage.

When the DC voltage changes every 50 ms, the sampling period is set to 50 ms or less.

The sampling period may be the same for the entire period at the time of detection, or may be changed to be shorter only for portions with changes.

The control unit (corresponding to the image output control unit 40) calculates a charge amount by integrating the digital voltage value converted by the A/D converter 203. At this time, the integration time may be determined in accordance with the number of rotations of the photoconductor 24 as described above, or may be determined in accordance with the time point when there are no changes in the DC current, by monitoring the DC current that flows through the photoconductor 24.

Further, the integration time may be determined by detecting the saturation of a surface potential using a relative surface electrometer which is inexpensive.

The calculation formula for calculating the photoconductor film thickness from the charge amount obtained by integrating the voltage is given below.

Photoconductor film thickness d=ε·(charge effective length)·(photoconductor diameter)·π·|Vp2−Vp1|/Q

Q indicates the detected charge amount, Vp1 indicates the applied DC voltage as the initial potential applied to the photoconductor 24 before detection, and Vp2 indicates the applied DC voltage applied to the photoconductor 24 at the time of detection.

When the initial film thickness before the photoconductor 24 is worn is known, the charge amount before the photoconductor 24 is worn may be measured as an initial charge amount, and the film thickness d may be obtained from the ratio of the initial charge amount to a detected charge amount measured next time when the photoconductor 24 is worn.

Photoconductor film thickness d=(initial film thickness)×(initial charge amount)/(detected charge amount)

When obtained in this way, there is no parameter term, and therefore it is possible to obtain the film thickness d significantly accurately by eliminating individual differences of the photoconductor 24 and individual differences of the charging unit 25.

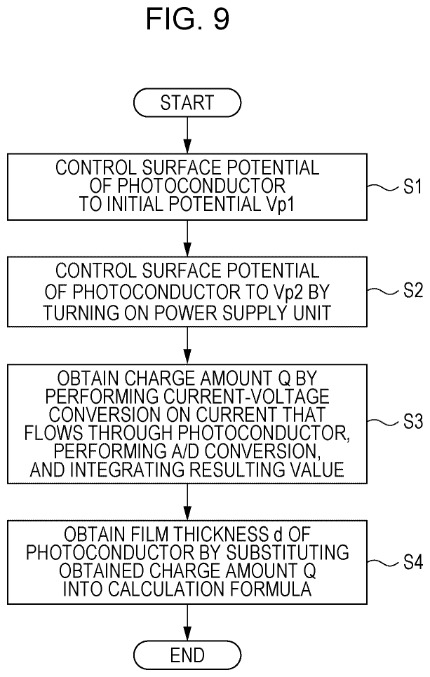

FIG. 9 is a flowchart for detecting the film thickness d of the photoconductor 24.

In the drawing, the control unit (corresponding to the image output control unit 40) controls the surface potential of the photoconductor 24 to the initial potential Vp1. Then, the control unit (corresponding to the image output control unit 40) controls the surface potential of the photoconductor 24 to Vp2 by turning on the power supply unit 210.

After that, the control unit (corresponding to the image output control unit 40) obtains the charge amount Q by performing a current-voltage conversion on the current that flows through the photoconductor 24, performing an A/D conversion, and integrating the resulting value.

The control unit (corresponding to the image output control unit 40) obtains the film thickness d of the photosensitive layer of the photoconductor 24 by substituting the obtained charge amount Q into the calculation formula.

When the film thickness d of the photosensitive layer of the photoconductor 24 is detected in this manner, the image output control unit 40 determines whether or not the film thickness d is equal to or less than the threshold dth.

Here, if it is determined that the film thickness d is not equal to or less than the threshold dth, the image output control unit 40 generates light amount adjustment data 2 (switching flag “0”) that enable setting the power supply voltage for the LPH 60 to the first power supply voltage V1, and sends the light amount adjustment data 2 to the power supply voltage control unit 119.

On the other hand, if it is determined that the film thickness d is equal to or less than the threshold dth, the image output control unit 40 sets the switch flag to “1”. Further, the image output control unit 40 generates light amount adjustment data 2 (switching flag “0”) that enable setting the power supply voltage for the LPH 60 to the second power supply voltage V2 (V1<V2), and sends the light amount adjustment data 2 to the power supply voltage control unit 119.

In this state, the power supply voltage control unit 119 supplies the first power supply voltage V1 or the second power supply voltage V2 as the power supply voltage for the LPH 60, in accordance with the film thickness d of the photosensitive layer of the photoconductor 24.

In this state, an image writing process by the LPH 60 is performed.

At this time, the image output control unit 40 holds the switching flag in a storage unit, and prepares for the next power supply voltage switching process.

In the present example, the number of times of switching of the power supply voltage for the LPH 60 is only one. Therefore, after the power supply voltage for the LPH 60 is switched from the first power supply voltage V1 to the second power supply voltage V2, the power supply voltage for the LPH 60 does not revert to the first power supply voltage V1 before the switching.

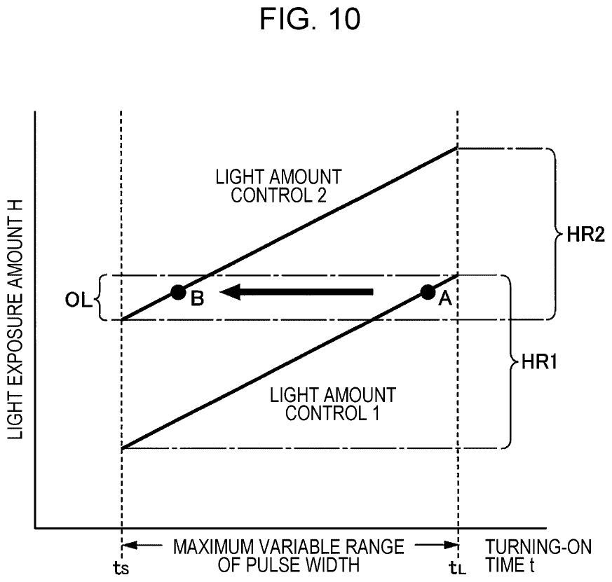

FIG. 10 illustrates an example of light amount control for the LPH according to the first exemplary embodiment.

In the drawing, the horizontal axis indicates a turning-on time t of the light emitting elements of the light emitting element chip U, and the vertical axis indicates a light exposure amount H.

Here, t_{S} indicates the minimum pulse width (e.g. 20 ns) of the turning-on time of the light emitting elements, and t_{L} indicates the maximum pulse width (e.g. 80 ns) of the turning-on time of the light emitting elements. Therefore, the range between t_{S} and t_{L} is the maximum variable range of the pulse width of the turning-on time.

In the present example, the light amount control 1 indicates the relationship between the turning-on time t of the light emitting elements and the light exposure amount H at the time when the power supply voltage for the LPH 60 is the first power supply voltage V1 (e.g. 2.65 V).

The light amount control 2 indicates the relationship between the turning-on time t of the light emitting elements and the light exposure amount H at the time when the power supply voltage for the LPH 60 is the second power supply voltage V2 (e.g. 3.3 V).

In both the light amount control 1 and the light amount control 2, the light exposure amount H increases in proportion to the turning-on time width. In the present example, first and second light amount control ranges with the light amount control 1 and the light amount control 2 are HR1 and HR2, respectively. In particular, in the present example, when selecting the first power supply voltage V1 and the second power supply voltage V2, the first light amount control range HR1 with the first power supply voltage V1 before the switching and the second light amount control range HR2 with the second power supply voltage V2 after the switching partially overlap each other. An overlapping region OL is selected so as to occupy a region of one-third or more of the second light amount control range HR2. Therefore, it is possible to emit light in a light amount in the range of one-third or more of the first light amount control range HR1 as the second light amount control range HR2 with the second power supply voltage V2, even after switching is made to the second power supply voltage V2.

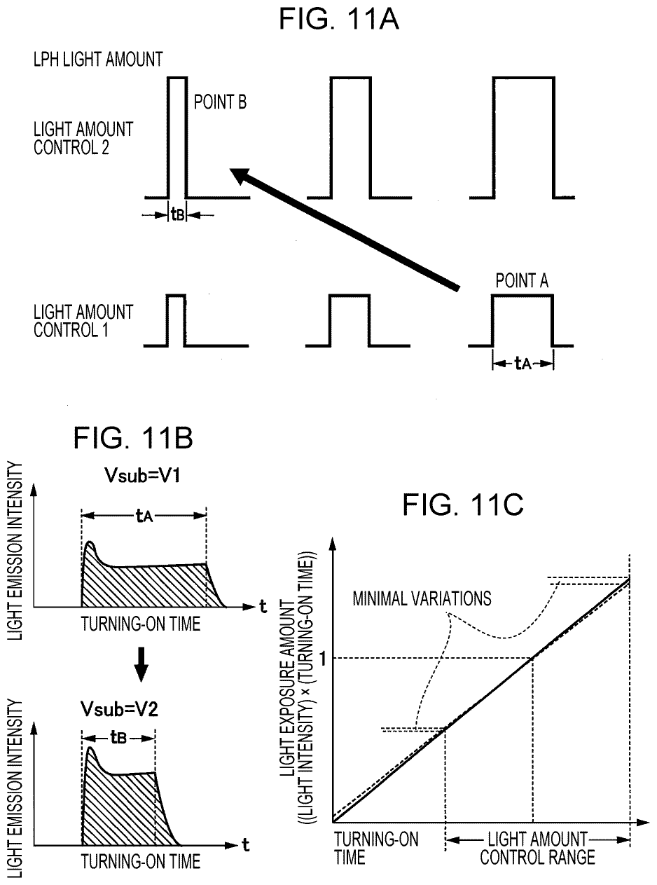

In the present example, the overlapping region OL is present between the first light amount control range HR1 and the second light amount control range HR2. Therefore, in the range of the overlapping region OL, as indicated by points A and B in FIG. 10, there are locations at which the same light exposure amount is obtained with the light amount control 1 and the light amount control 2 (see FIG. 11A).

However, as indicated in FIG. 11B, the shape of the graphs indicating the relationship between the light emission intensity and the turning-on time at points A and B is not an ideal rectangular shape. Therefore, the light exposure amount at point A with the first power supply voltage V1 and the light exposure amount at point B with the second power supply voltage V2 do not have exactly the same value.

Therefore, in the present example, as illustrated in FIGS. 6 and 11C, the light amount unevenness of the light amount characteristics of the light emitting elements is corrected by the linearity correction unit of the turning-on time control drive unit 118. However, a slight difference in color taste and color streaks of the image before and after the switching of the power supply voltage is unavoidable.

However, in the present example, the switching of the power supply voltage for the LPH 60 is not performed while the LPH 60 is performing an image writing process or standing by in an image writing process for an identical image (inter-image region). Therefore, the power supply voltage is not switched while the LPH 60 is performing an image writing process or standing by in an image writing process for an identical image. Accordingly, as mentioned above, there is no difference in color taste or color streaks of the image due to the switching of the power supply voltage.

In the present example, if the power supply voltage to be supplied to the LPH 60 is switched from the first power supply voltage V1 before the switching to the second power supply voltage V2 after the switching, subsequently switching is not made to the first power supply voltage V1 before the switching. Therefore, after switching is made to the second power supply voltage V2, a light amount difference phenomenon due to the switching to the first power supply voltage V1 is appropriately avoided.

In the present example, both the light amount control 1 and the light amount control 2 are performed using the maximum variable range of the pulse width of the turning-on time of the light emitting elements. However, this is not limiting. A region inside the maximum variable range of the pulse width of the turning-on time may be used, considering the fact that the light amount of the light emitting elements tends to be unstable around the maximum and minimum values of the maximum variable range of the pulse width of the turning-on time.

### Comparative Embodiment 1

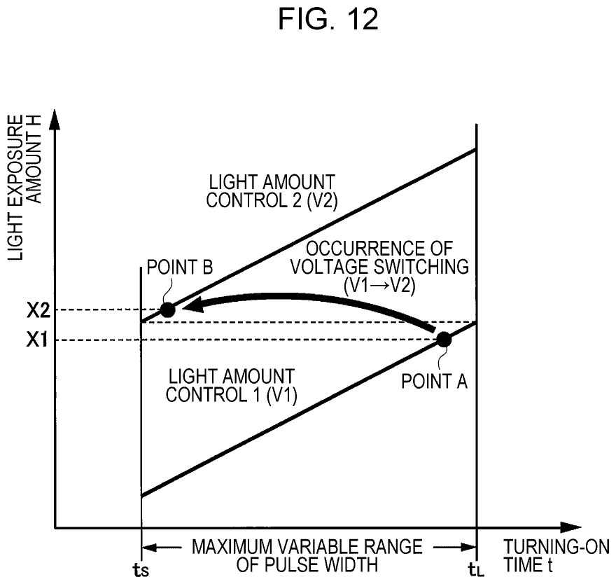

FIG. 12 illustrates an example of light amount control for an LPH that is used in Comparative Example 1.

In the drawing, the LPH according to the present example has light amount characteristics with light amount control 1 and light amount control 2, but is different from that according to the first exemplary embodiment.

First, the first light amount control range HR1 with the first power supply voltage V1 and the second light amount control range HR2 with the second power supply voltage V2 are disposed so as not to overlap each other.

In addition, the number of times of switching of the power supply voltage for the LPH is not limited.

In the case of the present example, a case where point A ((light exposure amount)×1) of the light amount control 1 and point B ((light exposure amount)×2) of the light amount control 2 are located around the switching point of the power supply voltage is described. In this case, it is necessary to obtain the light exposure amount of the light emitting elements by supplying either of the power supply voltages. Therefore, in order to obtain the light exposure amount around the switching point of the power supply voltage, it is necessary to perform the power supply voltage switching process each time, leading to changes in color taste and color streaks of the image.

Therefore, in the present embodiment, the defect caused by Comparative Embodiment 1 is effectively eliminated.

### Another Example of Light Amount Control for LPH

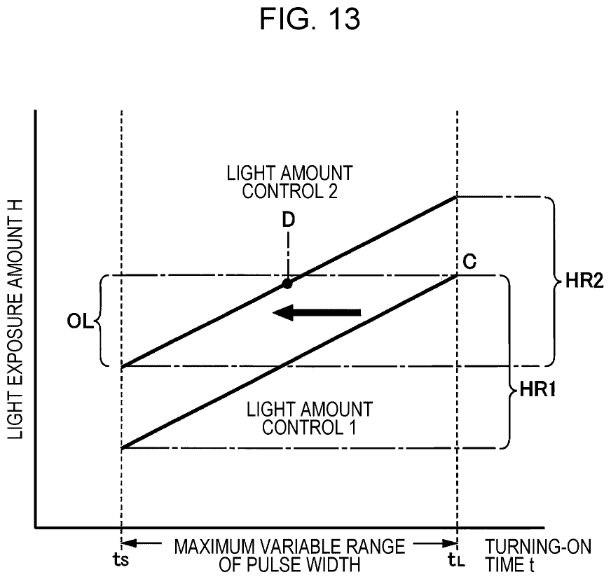

FIG. 13 illustrates another example of the light amount control for the LPH that is used in the first exemplary embodiment.

In the drawing, in the light amount control for the LPH, as is substantially similar to the aspect illustrated in FIG. 10, the first light amount control range HR1 with the first power supply voltage V1 before the switching and the second light amount control range HR2 with the second power supply voltage V2 after the switching partially overlap each other.

However, in the present example, differently from the aspect illustrated in FIG. 10, the overlapping region OL is selected so as to occupy a region of more than a half of the second light amount control range HR2. That is, in the present example, the first power supply voltage V1 and the second power supply voltage V2 are selected such that a maximum light amount value C of the first light amount control range HR1 is located in a region above a median light amount value D of the second light amount control range HR2.

Therefore, in the present example, it is possible to emit light in a light amount in the range of half or more of the first light amount control range HR1 as the second light amount control range HR2 with the second power supply voltage V2, even after switching is made to the second power supply voltage V2.

### Modified Embodiment 1

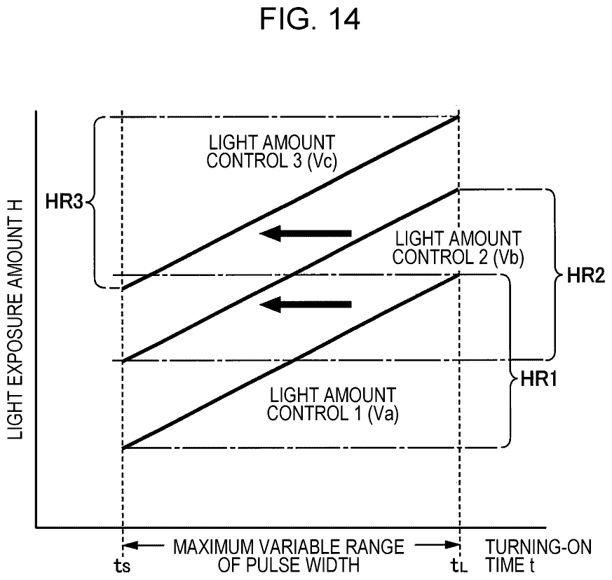

FIG. 14 illustrates an example of light amount control for an LPH that is used in Modified Embodiment 1.

In the drawing, the light amount control for the LPH is substantially similar to the first exemplary embodiment, but is different from the first exemplary embodiment in the following respects.
(1) In the present example, the number of times of switching of the power supply voltage for the LPH is a plural number of times (twice in the present example).
(2) In FIG. 14, light amount control 1 indicates the light amount characteristics of the light emitting elements with a power supply voltage Va. Light amount control 2 indicates the light amount characteristics of the light emitting elements with a power supply voltage Vb (Va<Vb). Light amount control 3 indicates the light amount characteristics of the light emitting elements with a power supply voltage Vc (Vb<Vc).
(3) In the present example, two thresholds dth1, dth2 (dth1>dth2) are selected for the film thickness d of the photosensitive layer of the photoconductor 24. In the first switching, a condition of whether or not the film thickness of the photoconductor 24 is equal to or less than the first threshold dth1 is used as the condition for switching the power supply voltage for the LPH. In the second switching, a condition of whether or not the film thickness of the photoconductor 24 is equal to or less than the second threshold dth2 is used.

According to the present example, when switching the power supply voltage, switching is made to the second power supply voltage V2 after the switching, which is higher than the first power supply voltage V1 before the switching.

In the case of the present example, switching is made from the power supply voltage Va (corresponding to the first power supply voltage V1 before the switching) to the power supply voltage Vb (corresponding to the second power supply voltage V2 after the switching) in the first switching of the power supply voltage, and switching is made from the power supply voltage Vb (corresponding to the first power supply voltage V1 before the switching) to the power supply voltage Vc (corresponding to the second power supply voltage V2 after the switching) in the second switching of the power supply voltage.

In the present example, a first light amount control range HR1, a second light amount control range HR2, and a third light amount control range HR3 for the light amount control 1, the light amount control 2, and the light amount control 3 are disposed to partially overlap each other. The overlapping range is selected such that the third light amount control range HR3 occupies one-third or more of the second light amount control range HR2, and the second light amount control range HR2 occupies one-third or more of the first light amount control range HR1.

Therefore, it is possible to emit light in a light amount in the range of one-third or more of the second light amount control range HR2 (or the first light amount control range HR1) as the third light amount control range HR3 (or the second light amount control range HR2) with the second power supply voltage V2, even after switching is made to the second power supply voltage V2.

### Modified Embodiment 2

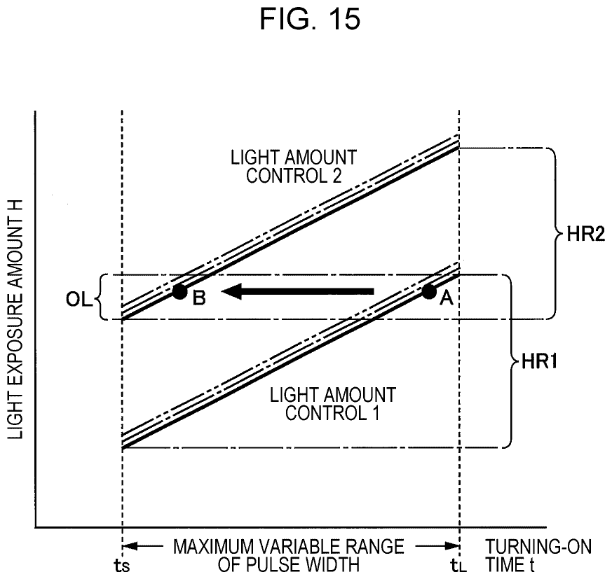

FIG. 15 illustrates an example of light amount control for an LPH that is used in Modified Embodiment 2.

In the drawing, the light amount control for the LPH is substantially similar to the first exemplary embodiment, but is different from the first exemplary embodiment in the following respects.
(1) In the present example, temperature information is different in accordance with the environment at the installation location of the image forming system 20, and may change the light amount characteristics of the LPH. In this case, as illustrated in FIG. 6, temperature information Jt may be taken into the image output control unit 40, and the power supply voltage to be supplied to the LPH may be corrected on the basis of the temperature information Jt. At this time, the light amount control 1 and the light amount control 2 are corrected as indicated by the dot-and-dash lines in FIG. 15.
(2) In the present example, each imaging engine 23 of the image forming system 20 may change the light amount characteristics of the LPH for each color in accordance with a color toner that is used. In this case, as illustrated in FIG. 6, color information Jc may be taken into the image output control unit 40, and the power supply voltage to be supplied to the LPH may be corrected on the basis of the color information Jc. At this time, the light amount control 1 and the light amount control 2 are corrected for each color as indicated by the double-dashed lines in FIG. 15.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A light emitting device comprising:
a light source unit in which a plurality of light emitting elements are arranged along a principal scanning direction;
a turning-on drive unit that outputs a turning-on signal for causing the light emitting elements to emit light to the light emitting elements, and that drives the light emitting elements to turn on so as to change a turning-on time width of the turning-on signal on a basis of a light amount of light to be emitted; and
a voltage switching unit that switches to change a power supply voltage to be supplied to the light emitting elements,
wherein the voltage switching unit includes a number limiting unit that limits a number of times of switching of the power supply voltage.
(((2)))

The light emitting device according to (((1))),
wherein the voltage switching unit limits the number of times of switching of the power supply voltage to one using the number limiting unit, and switching is made to a second power supply voltage after the switching that is higher than a first power supply voltage before the switching.
(((3)))

The light emitting device according to (((1))),
wherein the voltage switching unit limits the number of times of switching of the power supply voltage to a plural number of times determined in advance using the number limiting unit, and switching is made to a second power supply voltage after the switching that is higher than a first power supply voltage before the switching.
(((4)))

The light emitting device according to any one of (((1))) to (((3))),
wherein the voltage switching unit has a first light amount control range with a first power supply voltage before the switching and a second light amount control range with a second power supply voltage after the switching, the first light amount control range and the second light amount control range partially overlapping each other, with an overlapping region occupying one-third or more of the second light amount control range.
(((5)))

The light emitting device according to (((4))),
wherein the voltage switching unit selects the first power supply voltage and the second power supply voltage such that a maximum light amount value of the first light amount control range is located in a region above a median light amount value of the second light amount control range.
(((6)))

The light emitting device according to any one of (((1))) to (((5))),
wherein the turning-on drive unit uses, as the turning-on time width of the turning-on signal, a region inside a maximum variable region of the turning-on time width.
(((7)))

An optical writing device comprising:
the light emitting device according to any one of (((1))) to (((6))), the light emitting device being provided to face an image holding unit capable of holding an optical image; and
an imaging unit that forms an image on the image holding unit using light emitted from the light emitting elements of the light emitting device,
wherein the optical writing device writes the optical image onto the image holding unit.
(((8)))

An image forming system comprising:
an image holding unit capable of holding an optical image; and
the optical writing device according to (((7))),
wherein the image forming system visualizes the optical image held by the image holding unit and outputs the visualized optical image.
(((9)))

The image forming system according to (((8))),
wherein the voltage switching unit switches the power supply voltage depending on a state of use of the image holding unit.
(((10)))

The image forming system according to (((9))),
wherein the image holding unit includes a photoconductor covered with a photosensitive layer, and
the voltage switching unit switches the power supply voltage depending on a film thickness of the photosensitive layer.
(((11)))

The image forming system according to any one of (((8))) to (((10))),
wherein the voltage switching unit does not perform the switching of the power supply voltage while the optical writing device is performing an image writing process onto the image holding unit and while the optical writing device is standing by in an identical image writing process.
(((12)))

The image forming system according to (((11))),
wherein the voltage switching unit performs the switching of the power supply voltage when starting the image forming system.

What is claimed is:

1. A light emitting device comprising:
a light source unit in which a plurality of light emitting elements are arranged along a principal scanning direction;
a turning-on drive unit that outputs a turning-on signal for causing the light emitting elements to emit light to the light emitting elements, and that drives the light emitting elements to turn on so as to change a turning-on time width of the turning-on signal on a basis of a light amount of light to be emitted; and
a voltage switching unit that switches to change a power supply voltage to be supplied to the light emitting elements,
wherein the voltage switching unit includes a number limiting unit that limits a number of times of switching of the power supply voltage.

2. The light emitting device according to claim 1,
wherein the voltage switching unit limits the number of times of switching of the power supply voltage to one using the number limiting unit, and switching is made to a second power supply voltage after the switching that is higher than a first power supply voltage before the switching.

3. The light emitting device according to claim 1,
wherein the voltage switching unit limits the number of times of switching of the power supply voltage to a plural number of times determined in advance using the number limiting unit, and switching is made to a second power supply voltage after the switching that is higher than a first power supply voltage before the switching.

4. The light emitting device according to claim 1,
wherein the voltage switching unit has a first light amount control range with a first power supply voltage before the switching and a second light amount control range with a second power supply voltage after the switching, the first light amount control range and the second light amount control range partially overlapping each other, with an overlapping region occupying one-third or more of the second light amount control range.

5. The light emitting device according to claim 4,
wherein the voltage switching unit selects the first power supply voltage and the second power supply voltage such that a maximum light amount value of the first light amount control range is located in a region above a median light amount value of the second light amount control range.

6. The light emitting device according to claim 1,
wherein the turning-on drive unit uses, as the turning-on time width of the turning-on signal, a region inside a maximum variable region of the turning-on time width.

7. An optical writing device comprising:
the light emitting device according to claim 1, the light emitting device being provided to face an image holding unit capable of holding an optical image; and
an imaging unit that forms an image on the image holding unit using light emitted from the light emitting elements of the light emitting device,
wherein the optical writing device writes the optical image onto the image holding unit.

8. An optical writing device comprising:
the light emitting device according to claim 2, the light emitting device being provided to face an image holding unit capable of holding an optical image; and
an imaging unit that forms an image on the image holding unit using light emitted from the light emitting elements of the light emitting device,
wherein the optical writing device writes the optical image onto the image holding unit.

9. An optical writing device comprising:
the light emitting device according to claim 3, the light emitting device being provided to face an image holding unit capable of holding an optical image; and
an imaging unit that forms an image on the image holding unit using light emitted from the light emitting elements of the light emitting device,
wherein the optical writing device writes the optical image onto the image holding unit.

10. An optical writing device comprising:
the light emitting device according to claim 4, the light emitting device being provided to face an image holding unit capable of holding an optical image; and an imaging unit that forms an image on the image holding unit using light emitted from the light emitting elements of the light emitting device,
wherein the optical writing device writes the optical image onto the image holding unit.

11. An optical writing device comprising:
the light emitting device according to claim 5, the light emitting device being provided to face an image holding unit capable of holding an optical image; and
an imaging unit that forms an image on the image holding unit using light emitted from the light emitting elements of the light emitting device,
wherein the optical writing device writes the optical image onto the image holding unit.

12. An optical writing device comprising:
the light emitting device according to claim 6, the light emitting device being provided to face an image holding unit capable of holding an optical image; and
an imaging unit that forms an image on the image holding unit using light emitted from the light emitting elements of the light emitting device,
wherein the optical writing device writes the optical image onto the image holding unit.

13. An image forming system comprising:
an image holding unit capable of holding an optical image; and
the optical writing device according to claim 7,
wherein the image forming system visualizes the optical image held by the image holding unit and outputs the visualized optical image.

14. An image forming system comprising:
an image holding unit capable of holding an optical image; and
the optical writing device according to claim 8,
wherein the image forming system visualizes the optical image held by the image holding unit and outputs the visualized optical image.

15. An image forming system comprising:
an image holding unit capable of holding an optical image; and
the optical writing device according to claim 9,
wherein the image forming system visualizes the optical image held by the image holding unit and outputs the visualized optical image.

16. An image forming system comprising:
an image holding unit capable of holding an optical image; and
the optical writing device according to claim 10,
wherein the image forming system visualizes the optical image held by the image holding unit and outputs the visualized optical image.

17. The image forming system according to claim 13,
wherein the voltage switching unit switches the power supply voltage depending on a state of use of the image holding unit.

18. The image forming system according to claim 17,
wherein the image holding unit includes a photoconductor covered with a photosensitive layer, and
the voltage switching unit switches the power supply voltage depending on a film thickness of the photosensitive layer.

19. The image forming system according to claim 13,
wherein the voltage switching unit does not perform the switching of the power supply voltage while the optical writing device is performing an image writing process onto the image holding unit and while the optical writing device is standing by in an identical image writing process.

20. The image forming system according to claim 19,
wherein the voltage switching unit performs the switching of the power supply voltage when starting the image forming system.
